(19) United States
(12) Patent Application Publication
(10) Pub. No.: US 2011/0141249 A1
(43) Pub. Date: Jun. 16, 2011

(54) STEREO-IMAGE DISPLAY APPARATUS

(76) Inventors: HUANG-TZUNG JAN, Longtan Township (TW); Chih-Pei Chen, Longtan Township (TW); Ching-Chueh Yang, Longtan Township (TW)

(21) Appl. No.: 12/637,741

(22) Filed: Dec. 14, 2009

(51) Int. Cl. H04N 13/04

(52) U.S. Cl. 348/58; 348/E13.075

(57) ABSTRACT

A stereo-image display device is disclosed in the invention. The stereo-image display device includes a polarization beam splitter, an image projection lens set, a first image unit and a second image unit. The first image unit is used for generating a first visual optical signal to the polarization beam splitter. The second image unit is used for generating a second visual optical signal to the polarization beam splitter. A polarization direction of the second visual optical signal is orthogonal to a polarization direction of the first visual optical signal. Two visual optical signals are combined to one beam by the polarization beam splitter, and are projected through the image projection lens set onto a screen.

### BACKGROUND OF THE INVENTION

1. Field of the Invention

The invention relates to a stereo-image display apparatus and, more particularly, to a reflective panel stereo-image display apparatus and the optical structure thereof.

2. Description of the Prior Art

Recently, consumer electronic products are developing rapidly. Kinds of digital electronic display devices are popular in our daily life. Electronic display devices are implements in products like mobile phones, interactive advertisement panels, LCD televisions and laptop computers. In order to provide more real display effect, the electronic display device begins its revolution from two dimensional to three dimensional displaying.

Take the stereo movie for example, the audiences may wear a stereo eye glasses with red and blue optical filters. Each frame of the movie contains a left eye image and a right eye image with different color lights. The left eye and right eye images are filtered through different optical filters and respectively projected to two eyes of the audiences. A parallax existed between the left eye and right eye images are utilized to form a stereo vision to the audiences. This kind of stereo movies is well developed, but it has some color-bias problems in displaying.

Besides, the theory of stereo display with polarization glasses utilizes two projectors to cast left eye and right eye image synchronously. The polarization glasses are utilized to filter the left eye and right eye images, which are projected to two eyes of the audiences respectively. Please refer to FIG. 1. FIG. 1 is a schematic diagram illustrating a stereo-image display system 1 (e.g. stereo movie casting system) in prior art. It needs two independent projecting displayers (10, 12) for generating left eye and right eye images with vision messages, and projecting them onto one screen 14 synchronously. The images projected by these two independent projecting displayers (10, 12) have to be overlapping exactly, or the outcome image will be vague. In order to achieve ideal displaying effect, the implementations of the projecting displayers must be performed by a skilled engineer, such that the cost of the stereo display is still too high to be applied in personal or family applications.

Accordingly, the invention discloses a stereo-image display apparatus, which utilizes one singular display device for controlling the polarization state of optical signals and projecting left eye and right eye images on the same optical pattern synchronously, so as to solve said problems.

### SUMMARY OF THE INVENTION

A scope of the invention is to provide a stereo-image display apparatus. In practical applications, the stereo-image display apparatus can be a reflective panel stereo-image display apparatus.

According to an embodiment, the stereo-image display apparatus includes a polarization beam splitter, an image projection lens set, a first image unit and a second image unit. The first image unit is used for generating a first visualized optical signal and projecting the first visualized optical signal to the polarization beam splitter. The second image unit is used for generating a second visualized optical signal and projecting the second visualized optical signal to the polarization beam splitter. A polarization state of the first visualized optical signal is orthogonal to a polarization state of the second visualized optical signal.

When the first visualized optical signal and the second visualized optical signal enter the polarization beam splitter, the first visualized optical signal and the second visualized optical signal are combined to one combined beam by the polarization beam splitter. The combined beam is projected through the image projection lens set onto a screen.

According to another embodiment, the stereo-image display apparatus includes a polarization beam splitter, an image projection lens set, a first image unit and a second image unit. The first image unit is used for generating a first visualized optical signal and projecting the first visualized optical signal to the polarization beam splitter. The second image unit is used for generating a second visualized optical signal and projecting the second visualized optical signal to the polarization beam splitter. A polarization direction of the first visualized optical signal is perpendicular to a polarization direction of the second visualized optical signal.

When the first visualized optical signal and the second visualized optical signal enter the polarization beam splitter, the first visualized optical signal and the second visualized optical signal are combined to one combined beam by the polarization beam splitter. The combined beam is projected through the image projection lens set onto a screen.

Compared to the stereo-image display device in prior art (e.g. polar optical displayer), the invention utilizes the polarization beam splitter to combine two visualized optical signal with left eye and right eye visual messages. Then, the combined beam is projected on the screen capable of maintaining optical polarization. In this case, the audiences may wearing a stereo eye glasses with differential polarization state filters may see the stereo vision image clearly.

Accordingly, once the digital signals with left eye vision and right eye vision messages are inputted to the stereo-image display apparatus in the invention, the stereo-image display apparatus may broadcast a stereo image. It needs no complex implementation operation. The stereo-image display apparatus can be applied in family application. Besides, the invention utilizes two polarization states of one regular light source, such that it has higher energy utilization efficiency.

The advantage and spirit of the invention may be understood by the following recitations together with the appended drawings.

### BRIEF DESCRIPTION OF THE APPENDED DRAWINGS

FIG. 1 is a schematic diagram illustrating a stereo-image display system in prior art.

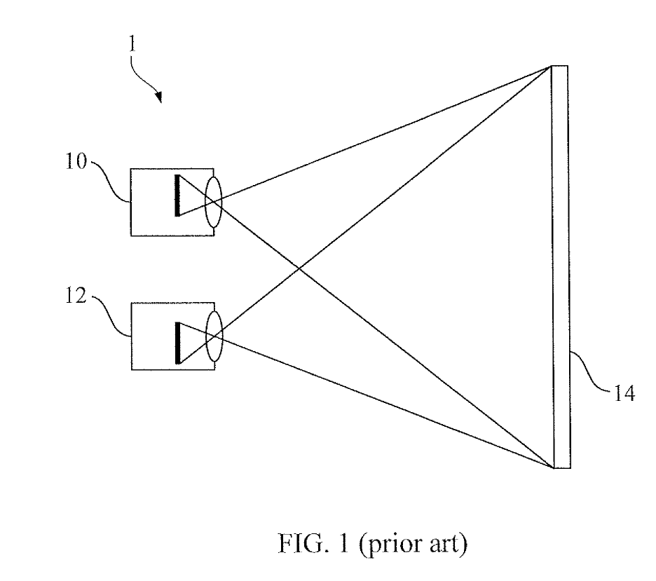

FIG. 2 is a schematic diagram illustrating a stereo-image display apparatus according to an embodiment of the invention.

FIG. 3 is a schematic diagram illustrating a stereo-image display apparatus according to another embodiment of the invention.

### DETAILED DESCRIPTION OF THE INVENTION

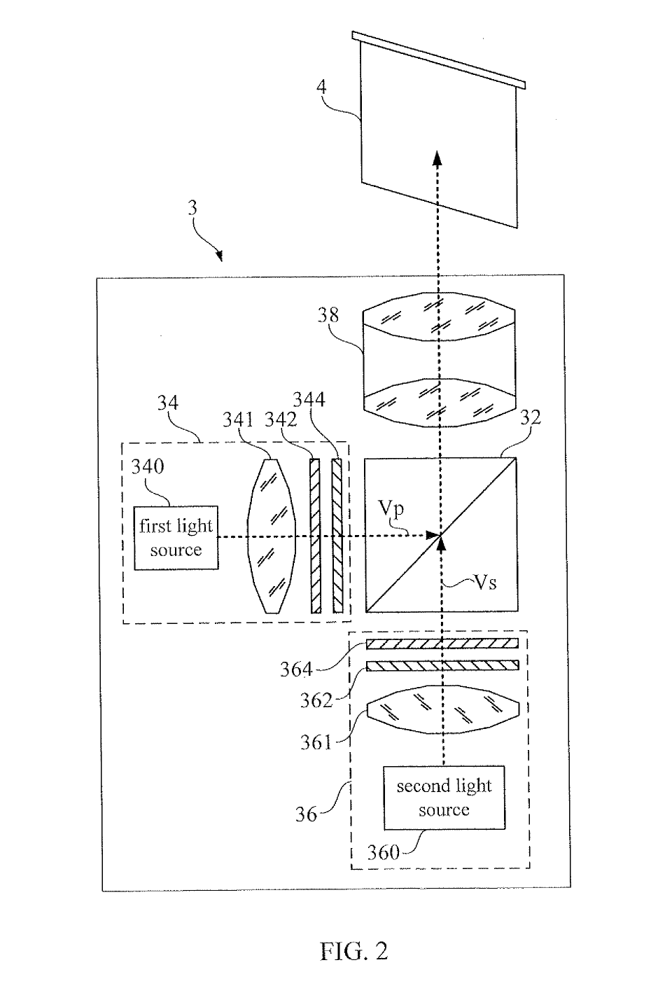

Please refer to FIG. 2. FIG. 2 is a schematic diagram illustrating a stereo-image display apparatus 3 according to an embodiment of the invention. As shown in FIG. 2, the stereo-image display apparatus 3 includes a polarization beam splitter 32, a first image unit 34, a second image unit 36 and an image projection lens set 38.

The first image unit 34 is used for generating a first visualized optical signal and projecting the first visualized optical signal to the polarization beam splitter 32. The second image unit 36 is used for generating a second visualized optical signal and projecting the second visualized optical signal to the polarization beam splitter 32. To be notice that, a polarization direction of the first visualized optical signal is orthogonal (perpendicular) to a polarization direction of the second visualized optical signal.

As shown in FIG. 2, the first image unit 34 includes a first light source 340, a first polarizer 342 and a first liquid crystal display (LCD) panel 344. In this embodiment, the first light source can be a white light-emitting diode component for generating a parallel beam.

In practical applications, the first image unit 34 may further include a condensing lens 341 (as shown in FIG. 2). The condensing lens 341 is disposed between the first light source 340 and the first polarization beam splitter 342. The condensing lens 341 may redirect some scattering light generated by the white light-emitting diode component, so as to cooperate with the first light source 340 for generating a stable and even parallel beam.

Then, the first beam goes through the first polarizer 342 and the first LCD panel 344 in sequence. The polarization direction of the first beam is adjusted to be P-polarized by the first polarizer 342. The first beam after adjustment is projected through the first LCD panel 344 for forming the first visualized optical signal Vp. In this embodiment, the first visualized optical signal Vp, which is projected across the first LCD panel 344, may correspond to a left eye vision.

On the other hand, the second image unit 36 includes a second light source 360, a second polarizer 362 and a second LCD panel 364. In this embodiment, the second light source may also be a white light-emitting diode component.

In practical applications, the second image unit 36 may further include another condensing lens 361 (as shown in FIG. 2). The condensing lens 361 is disposed between the second light source 360 and the second polarization beam splitter 362. The condensing lens 341 may redirect some scattering light generated by the white light-emitting diode component, so as to cooperate with the second light source 340 for generating a stable and even parallel beam.

Then, the second beam goes through the second polarizer 362 and the second LCD panel 364 in sequence. To be noticed that, the polarization direction of the second beam is adjusted to be S-polarized by the first polarizer 342. The second beam after adjustment is projected through the second LCD panel 364 for forming the second visualized optical signal Vs. In this embodiment, the second visualized optical signal Vs, which is projected across the second liquid crystal display panel 364, may correspond to a right eye vision.

In other words, the first image unit 34 and the second image unit 36 may respectively generate the P-polarized first visualized optical signal Vp and the S-polarized second visualized optical signal Vs. In this embodiment, the first visualized optical signal Vp and the second visualized optical signal Vs carry the messages of the left eye vision and the right eye vision respectively, but the invention is not limited to this.

In other embodiment, the first visualized optical signal Vp can be assigned to carry the message of right eye vision by adjusting the first LCD panel 344, and the second visualized optical signal Vs can be assigned to carry the message of left eye vision by adjusting the second LCD panel 364. In the meantime, the stereo eye glasses worn by audiences must have the corresponding configuration of S-polarization filter and P-polarization filter, which are disposed within the frames for spectacles in front of eyes of audiences.

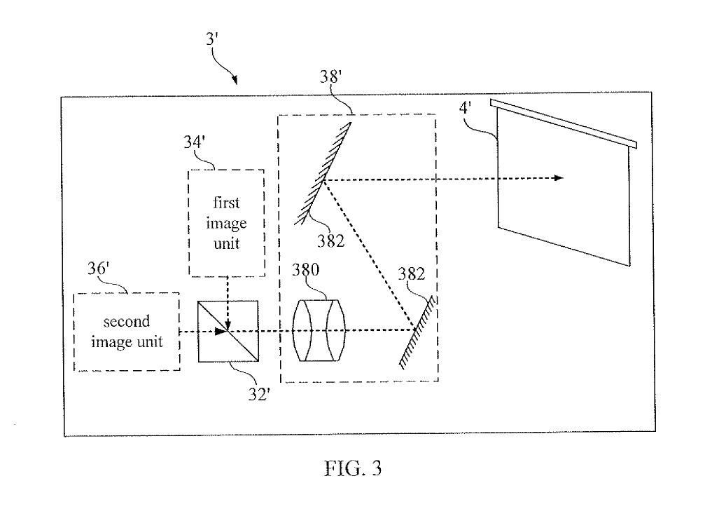

As shown in FIG. 2, when the first visualized optical signal Vp (P-polarized) enters the polarization beam splitter 32 and passes a polarization selective plane 320 in the polarization beam splitter 32, the first visualized optical signal Vp is reflected by the polarization selective plane 320, such that the first visualized optical signal Vp turns a specific angle (in this FIG. 3B case, it turns 90° upward) and is projected to the image projection lens set 38. On the other hand, when the second visualized optical signal Vs enters the polarization beam splitter 32, the second visualized optical signal Vs passes through the polarization selective plane 320 in a straight line and goes directly to the image projection lens set 38. In this way, the first visualized optical signal Vp and the second visualized optical signal Vs are converged on one optical pattern to form one combined beam.

In other words, the polarization beam splitter 32 is utilized to reflect and bend one visualized optical signal of the first visualized optical signal Vp and the second visualized optical signal Vs, and allow the other visualized optical signal penetrating in a straight line. Accordingly, the first visualized optical signal and the second visualized optical signal are combined to one combined beam.

Based on the characteristic of two visualized optical signals with perpendicular polarization directions while passing the polarization selective plane 320 the polarization beam splitter 32, the first visualized optical signal Vp (P-polarized) and the second visualized optical signal Vs (S-polarized) are converged into one combined beam. The first visualized optical signal Vp (P-polarized) and the second visualized optical signal Vs (S-polarized) correspond to a left eye vision and a right eye vision respectively.

At last, the combine beam (including the first visualized optical signal Vp and the second visualized optical signal Vs) is projected through the image projection lens set 38 onto a screen 4. In this way, audiences wearing stereo eye glasses with S-polarization filter and P-polarization filter may see the stereo vision image clearly. In practical applications, the screen 4 can be a screen capable of maintaining optical polarization.

Besides, the image projection lens set 38 in the aforesaid embodiment is a front projection lens, such that the stereo-image display apparatus 3 is a front projecting stereo-image display device in this case, but the invention is not limited to this.

Please refer to FIG. 3. FIG. 3 is a schematic diagram illustrating a stereo-image display apparatus 3′ according to another embodiment of the invention. In this embodiment, the stereo-image display apparatus 3′ includes a polarization beam splitter 32′, a first image unit 34′, a second image unit 36′ and an image projection lens set 38′.

The main difference between the stereo-image display apparatus 3′ and the aforesaid embodiment is that, the image projection lens set 38′ of the stereo-image display apparatus 3′ includes a fixed-focus lens 380 and two reflecting mirrors 382. The visualized optical signals go through the fixed-focus lens 380. Then the visualized optical signals are sequentially reflected by two reflecting mirrors 382 and projected to the screen 4′. The fixed-focus lens 380 and these two reflecting mirrors 382 form a back projection lens set, such that the stereo-image display apparatus 3′ is a back projecting stereo-image display device (e.g. back projecting television). Other internal components and operating behaviors of the stereo-image display apparatus 3′ in this embodiment are similar to the aforesaid embodiment, so not to be repeated here.

In summary, the invention utilizes the polarization beam splitter to combine two visualized optical signal with left eye and right eye visual messages. Then, the combined beam is projected through the image projection lens set onto the screen capable of maintaining optical polarization. In this case, the audiences may wearing a stereo eye glasses with differential polarization state filters may see the stereo vision image clearly.

In aforesaid embodiments, the first visualized optical signal and the second visualized optical signal are linear polarized (e.g. S-polarized or P-polarized), but the invention is not limited to linear polarized radiation.

In another embodiment, the first visualized optical signal can be a left-hand elliptically polarization beam, and the second visualized optical signal can be a right-hand elliptically polarization beam. Or alternatively, the first visualized optical signal can be a right-hand elliptically polarization beam, and the second visualized optical signal can be a left-hand elliptically polarization beam. In this case, the invention may generate a pair of orthogonal visualized optical signals with left-hand and right-hand elliptically polarization. The visualized optical signals with left and right eye messages are combined to one combined beam by the specific polarization beam splitter, in order to form a stereo vision on a screen. In other words, the stereo-image display apparatus may also adopt elliptically polarization beam. Other internal components and operating behaviors of the stereo-image display apparatus are substantially similar to the aforesaid embodiment, so not to be repeated here.

Accordingly, once the digital signals with left eye vision and right eye vision messages are inputted to the stereo-image display apparatus in the invention, the stereo-image display apparatus may broadcast a stereo image. It needs no complex implementation operation. The stereo-image display apparatus can be applied in family application. The stereo-image display apparatus may also be utilized to broadcast a regular movie without stereo visions. Because the stereo-image display apparatus in the invention has two sets of image units (and light sources), it may achieve double brightness while broadcasting a regular movie.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A stereo-image display apparatus, comprising:
a polarization beam splitter;
an image projection lens set;
a first image unit, used for generating a first visualized optical signal and projecting the first visualized optical signal to the polarization beam splitter; and
a second image unit, used for generating a second visualized optical signal and projecting the second visualized optical signal to the polarization beam splitter, a polarization state of the first visualized optical signal being orthogonal to a polarization state of the second visualized optical signal;
wherein the first visualized optical signal and the second visualized optical signal are combined to one combined beam by the polarization beam splitter, and the combined beam is projected through the image projection lens set onto a screen.

2. The stereo-image display apparatus of claim 1, wherein one visualized optical signal of the first visualized optical signal and the second visualized optical signal is reflected and bended by the polarization beam splitter, and the other visualized optical signal penetrates the polarization beam splitter, such that the first visualized optical signal and the second visualized optical signal are combined to one combined beam.

3. The stereo-image display apparatus of claim 1, wherein the first image unit comprises a first light source, a first polarizer and a first liquid crystal display panel, the light source is used for generating a first beam, the first beam is adjusted to be an elliptically polarization beam by the first polarizer, and the first beam is projected through the first liquid crystal display panel for forming the first visualized optical signal.

4. The stereo-image display apparatus of claim 1, wherein the second image unit comprises a second light source, a second polarizer and a second liquid crystal display panel, the light source is used for generating a second beam, the second beam is adjusted to be an elliptically polarization beam by the second polarizer, the polarization state of the second beam is orthogonal to the polarization state of the first beam, and the second beam is projected through the second liquid crystal display panel for forming the second visualized optical signal.

5. The stereo-image display apparatus of claim 1, wherein the first visualized optical signal and the second visualized optical signal correspond to a left eye vision and a right eye vision respectively.

6. The stereo-image display apparatus of claim 1, wherein the light source comprises a white light-emitting component.

7. The stereo-image display apparatus of claim 1, wherein the screen is a screen capable of maintaining optical polarization.

8. The stereo-image display apparatus of claim 1, wherein the image projection lens set comprises a front projection lens.

9. The stereo-image display apparatus of claim 1, wherein the image projection lens set comprises a fixed-focus lens and two reflecting mirrors, the first visualized optical signal and the second visualized optical signal go through the fixed-focus lens, then the first visualized optical signal and the second visualized optical signal are sequentially reflected by two reflecting mirrors and projected to the screen, and the fixed-focus lens and the reflecting mirrors form a back projection lens set, such that the stereo-image display apparatus is a back-projecting stereo-image display apparatus.

10. A stereo-image display apparatus, comprising:
a polarization beam splitter;
an image projection lens set;
a first image unit, used for generating a first visualized optical signal and projecting the first visualized optical signal to the polarization beam splitter; and
a second image unit, used for generating a second visualized optical signal and projecting the second visualized optical signal to the polarization beam splitter, a polarization direction of the first visualized optical signal being perpendicular to a polarization direction of the second visualized optical signal;
wherein the first visualized optical signal and the second visualized optical signal are combined to one combined beam by the polarization beam splitter, and the combined beam is projected through the image projection lens set onto a screen.

11. The stereo-image display apparatus of claim 10, wherein one visualized optical signal of the first visualized optical signal and the second visualized optical signal is reflected and bended by the polarization beam splitter, and the other visualized optical signal penetrates the polarization beam splitter, such that the first visualized optical signal and the second visualized optical signal are combined to one combined beam.

12. The stereo-image display apparatus of claim 10, wherein the first image unit comprises a first light source, a first polarizer and a first liquid crystal display panel, the light source is used for generating a first beam, a polarization direction of the first beam is adjusted to be P-polarized by the first polarizer, and the first beam is projected through the first liquid crystal display panel for forming the first visualized optical signal.

13. The stereo-image display apparatus of claim 10, wherein the second image unit comprises a second light source, a second polarizer and a second liquid crystal display panel, the light source is used for generating a second beam, a polarization direction of the second beam is adjusted to be S-polarized by the second polarizer, and the second beam is projected through the second liquid crystal display panel for forming the second visualized optical signal.

14. The stereo-image display apparatus of claim 10, wherein the first visualized optical signal and the second visualized optical signal correspond to a left eye vision and a right eye vision respectively.

15. The stereo-image display apparatus of claim 10, wherein the light source comprises a white light-emitting component.

16. The stereo-image display apparatus of claim 10, wherein the screen is a screen capable of maintaining optical polarization.

17. The stereo-image display apparatus of claim 10, wherein the image projection lens set comprises a front projection lens.

18. The stereo-image display apparatus of claim 10, wherein the image projection lens set comprises a fixed-focus lens and two reflecting mirrors, the first visualized optical signal and the second visualized optical signal go through the fixed-focus lens, then the first visualized optical signal and the second visualized optical signal are sequentially reflected by two reflecting mirrors and projected to the screen, and the fixed-focus lens and the reflecting mirrors form a back projection lens set, such that the stereo-image display apparatus is a back-projecting stereo-image display apparatus.
